(19) United States
(12) Patent Application Publication
(10) Pub. No.: US 2007/0228712 A1
(43) Pub. Date: Oct. 4, 2007

(54) Vehicle restraint systems and methods of restraining vehicle occupants

(76) Inventors: Robert T. Hansen, Clearfield, UT (US); Ann Hansen, Clearfield, UT (US); Mark T. Viehweg, Salt Lake City, UT (US)

Correspondence Address: TRASK BRITT, P.O. BOX 2550, SALT LAKE CITY, UT, 84110, US

(21) Appl. No.: 11/397,458

(22) Filed: Apr. 4, 2006

(51) Int. Cl. B60R 21/02; B60R 22/00

(52) U.S. Cl. 280/748; 297/484; 280/801.1

(57) ABSTRACT

Restraint systems for vehicle occupants are disclosed. Particularly, restraint bars configured to pivot on a shaft to a restraining position across the lap of a seated vehicle occupant are disclosed. The shaft of the restraint bar may be operably coupled with a ratchet wheel. The position of the ratchet wheel, and thus the position of the restraint bar may be controlled using at least one pawl, engageable with teeth of the ratchet wheel. A release mechanism may disengage the at least one pawl from the teeth of the ratchet, enabling the restraint bar to pivot freely. The restraint bar may be vertically or horizontally adjustable with respect to the seated occupant. In addition, the seat of the occupant may be horizontally adjustable.

### FIELD OF THE INVENTION

The present invention relates generally to occupant restraint systems for vehicles and methods of restraining vehicle occupants.

### BACKGROUND OF THE INVENTION

Industrial machinery including construction vehicles, such as front-end loaders and bulldozers, as well as mining equipment may not be well-suited for use of an occupant restraint system such as a conventional seat belt used in an automobile. The dirty environmental conditions may cause the latch and belt winding system of a conventional seat belt system to jam creating a dangerous situation for an occupant that needs to exit the vehicle rapidly. Occupants of industrial vehicles without a restraint system may risk hitting their head on the roof of the vehicle as the vehicle travels over rough terrain. Unrestrained occupants may be thrown from a vehicle in an accident.

One conventional restraint system for use in industrial machinery is described in U.S. Pat. No. 6,299,207 to Bares. An operator restraint bar is mounted on the real wall of the vehicle cab, and movable from a restraint position to a raised position with one end adjacent to the roof of the cab. The restraint bar is U-shaped, and includes a lap bar and a pair of side arms which pivot to move between the raised position and the restraint position. The lap bar remains oriented parallel to the shoulders of an operator, in both the raised position and the restraint position. Because the restraint bar remains overhead of the operator, the operator may hit their head on the restraint bar while exiting the vehicle. In addition, the restraint bar is not fully adjustable to accommodate operators of different sizes and body types.

As may also be appreciated, it would be advantageous to provide a restraint system which is easily and quickly operable, and suitable for use by operators of various sizes.

### BRIEF SUMMARY OF THE INVENTION

One embodiment of the present invention comprises a restraint system for an occupant of a vehicle having a positioning mechanism, a shaft protruding from the positioning mechanism, the shaft rotatable in a first direction and releasably fixed from rotation in a second, opposing direction, a release mechanism coupled with the positioning mechanism which may be manipulated by the occupant to enable the shaft to rotate in the second, opposing direction, and a restraint bar coupled with the shaft to pivot with the shaft between at least two restraining positions and an open position.

The restraint system may include a housing enclosing the positioning mechanism, the shaft protruding from the housing. The positioning mechanism may include a ratchet wheel rotatable with the shaft and having a plurality of teeth circumferentially disposed thereabout, and at least one positioning pawl engageable with the plurality of teeth of the ratchet. The release mechanism may comprise a mechanism configured to disengage the positioning pawl from the plurality of teeth of the ratchet. An uplock pawl engageable with the ratchet wheel while the restraint bar is in the open position may be included. A counterweight may be operably coupled with the shaft.

The restraint bar may be L-shaped, with a first portion and a second portion orthogonally disposed to the first portion. The L-shaped restraint bar may be coupled with the shaft by a linkage comprising a first bell crank attached to the shaft. A linkage bar may connect the first bell crank with a second bell crank. A second shaft may be attached to the second bell crank and a shaft hub may secure the second shaft with an end of the restraint bar. In one embodiment, the restraint bar may be coupled with the shaft by a linkage including a first bell crank attached to the shaft and a first linkage bar connecting the first bell crank with a second bell crank. A second linkage bar may connect the second bell crank with a third bell crank. A second shaft may be attached to the third bell crank and a shaft hub may secure the second shaft with an end of the restraint bar.

An armor plate may be attached to the restraint bar. In one embodiment, the restraint bar may include an elongated, annular bar having a cavity therein, and the armor plate including a substantially planar portion extending in a radial direction from the restraint bar and a fan-shaped attachment portion receivable by the cavity of the restraint bar.

Another embodiment of the present invention is a method of restraining an occupant of a vehicle including providing a seat for the vehicle occupant comprising a seat back and a seat bottom. A restraint bar may pivot in a plane substantially parallel to a plane of the seat back to a first position near a lap of the vehicle occupant and the upward pivoting action of the restraint bar may be prevented. The restraint bar may be pivoted to a second position closer to the lap of the vehicle occupant. Preventing upward pivoting action of the restraint bar may comprise engaging directional teeth of a ratchet wheel with a pawl, the ratchet wheel coupled with restraint bar to rotate therewith. A release mechanism operably coupled with the restraint bar may be manipulated, and the restraint bar pivoted upward to a third, substantially vertical position. Manipulating the release mechanism may include rotating a release shaft, having eccentric longitudinal portions contacting the pawl, and pivoting the pawl and releasing the directional teeth of the ratchet from engagement with the pawl. The pawl may be biased toward engagement with the directional teeth of the ratchet wheel. Optionally, a plurality of pawls may be biased toward engagement with the directional teeth of the ratchet wheel.

Yet another embodiment of the present invention is a restraint system for an occupant of a vehicle which includes a positioning mechanism. The positioning mechanism has a ratchet wheel having a plurality of directional teeth circumferentially disposed thereon, at least one pawl having a first end biased toward engagement with the ratchet wheel, a release shaft having an eccentric longitudinal portion, the eccentric longitudinal portion contacting a second end of the pawl shaft, and a restraint bar shaft attached to the ratchet wheel. A restraint bar is coupled with the restraint bar shaft to be pivotable between at least two restraining positions and an open position. The restraint system may further include an uplock pawl having a first end biased toward engagement with the ratchet wheel and an uplock notch in the ratchet wheel configured to receive the first end of the uplock pawl and prevent rotation of the ratchet wheel. Optionally, an armor plate may extend from the restraint bar.

Other features and advantages of the present invention will become apparent to those of skill in the art through consideration of the ensuing description, the accompanying drawings, and the appended claims.

### BRIEF DESCRIPTION OF THE SEVERAL VIEWS OF THE DRAWINGS

The foregoing and other advantages of the present invention will become apparent upon review of the following detailed description and drawings in which:

FIG. 1A shows a vehicle having a restraint system of the present invention;

FIG. 1B depicts the seat and rails of the restraint system of FIG. 1A;

FIG. 2 shows a cross-sectional view of a positioning mechanism of the present invention;

FIG. 3 shows a side cross-sectional view of the positioning mechanism of FIG. 2;

FIG. 4A shows a side view of a portion of the positioning mechanism of FIG. 2;

FIG. 4B shows a top view of the portion of the positioning mechanism of FIG. 4A;

FIG. 5A illustrates an adjustment mechanism for a positioning mechanism of the present invention;

FIG. 5B illustrates a top view of the adjustment mechanism of FIG. 5A;

FIG. 6A depicts another embodiment of a restraint system of the present invention;

FIG. 6B illustrates a side view of the restraint system of FIG. 6A;

FIG. 7 shows yet another embodiment of a restraint system of the present invention;

FIG. 8A shows another embodiment of a restraint bar of the present invention;

FIG. 8B shows a side view of the restraint bar of FIG. 8A;

FIG. 8C depicts the armor plate of the restraint bar of FIG. 8A;

FIG. 9A shows yet another embodiment of a restraint bar of the present invention;

FIG. 9B shows a side view of the restraint bar of FIG. 9A;

FIG. 9C depicts the armor plate of the restraint bar of FIG. 9A; and

FIG. 10 depicts a restraint system of the present invention including armor side plates.

### DETAILED DESCRIPTION OF THE INVENTION

The restraint system according to the present invention may be used in a variety of applications, such as for vehicles used in the mining or construction industry, or for use in the defense industry, where rapid egress from a vehicle may be desirable.

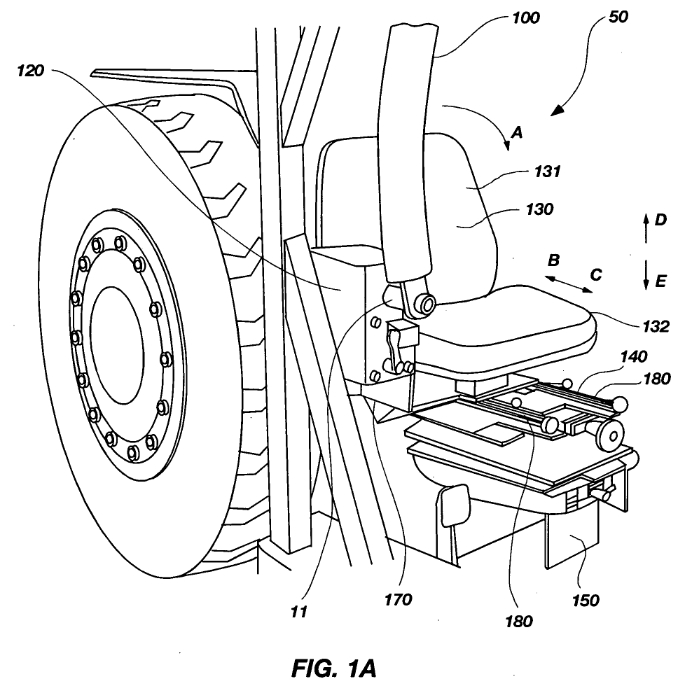

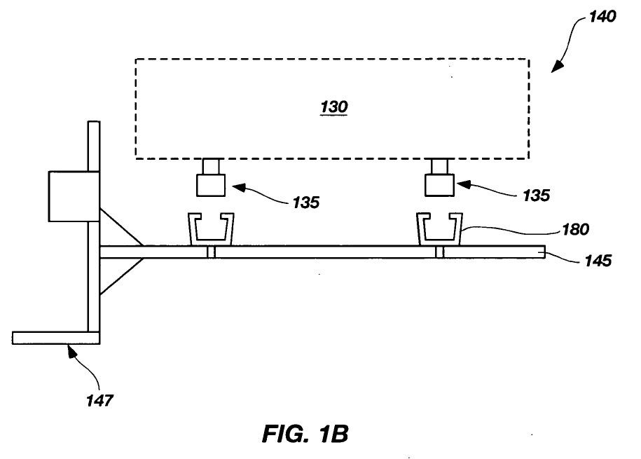

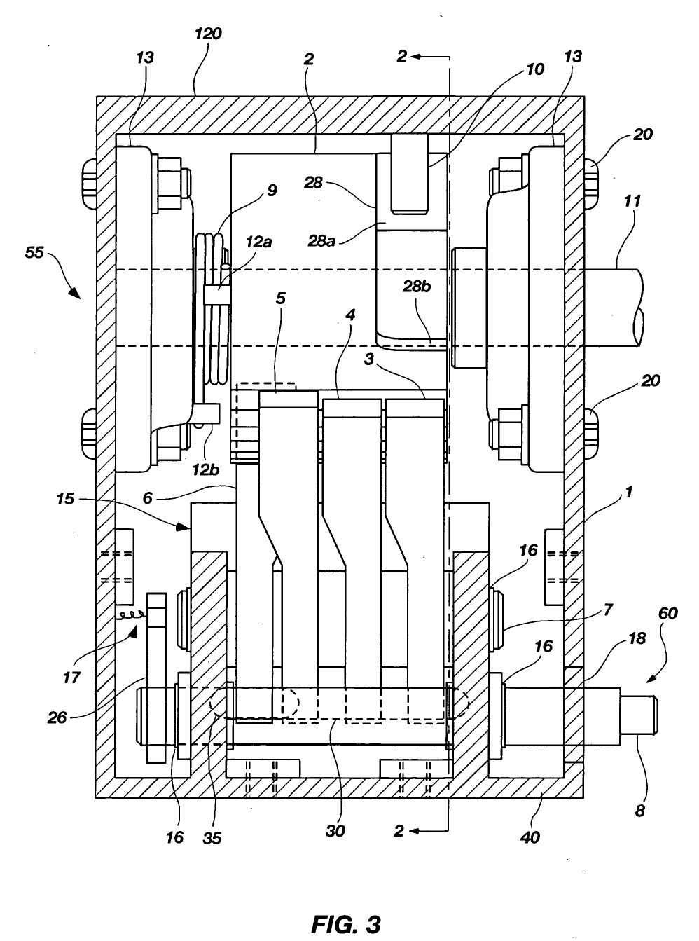

A first embodiment of restraint system 50 according to the present invention is depicted in FIG. 1A. A restraint bar 100 is mounted on a shaft 11. The shaft 11 passes into a positioning mechanism housing 120. The restraint bar 100 is shown in a generally vertical, open position for operator ingress and egress, and may pivot about the shaft 11 in the direction of arrow A to a generally horizontal, operator restrained position. A release lever 170, mounted on a release shaft 8 (see FIG. 3) may extend from the positioning mechanism housing 120, and may be manipulated by the occupant to release the shaft 11, and therefore the restraint bar 100. The restraint bar 100 may be locked in the open position, and require manipulation of the release lever 170 to lower the restraint bar 100 to the generally horizontal, operator restrained position. Likewise, once lowered beyond a predetermined point toward the operator restrained position, the release lever must be manipulated to raise the restraint bar 100 to the open position. The restraint bar 100 may be lowered to a plurality of different operator restrained positions. A positioning mechanism, described in detail hereinbelow, includes a plurality of predetermined operator restrained positions, which may be selected by bring the restraint bar 100 down to the desired position.

The positioning mechanism housing 120 is adjacent a seat 130 for the operator. The seat 130 may be mounted on an adjustment mechanism 140, depicted as a pair of rails 180 that the seat may slide upon. A single rail sliding mount and other fore and aft seat adjustment mechanisms are also within the scope of the present invention. The adjustment mechanism 140 enables the seat 130 to be adjusted with respect to any operating controls (not shown) of the vehicle, and with respect to the restraint bar 100 and the positioning mechanism housing 120. The seat adjustment mechanism 140 may provide forward or backward adjustment from the view of a seated operator, in the directions of arrows B and C. Adjusting the seat 130 forward or backward with respect to the positioning mechanism housing 120 will also adjust the position of the restraint bar 100 on the lap of a seated operator. The seat 130 includes a seat back 131 and a seat bottom 132. The restraint bar 100 may pivot in a plane substantially parallel to the seat back 131.

FIG. 1B depicts one embodiment of the seat adjustment mechanism 140 in greater detail. The seat 130 includes protruding tracks 135 which may be received by the rails 180. The rails 180 may be mounted on an adaptor plate 145. The adaptor plate 145 may be attached directly to the vehicle, or to an optional suspension mount 150, shown in FIG. 1A and described hereinbelow. A bracket 147 for the positioning mechanism housing 120 may be attached to an end of the adaptor plate 145. The mechanism housing 120 is thus fixed with respect to the rails 180 in the fore and aft direction.

Returning to FIG. 1A, the vehicle may optionally include a suspension mount 150 for the seat 130. Particularly with underground mining vehicles, the vehicle may undergo a great deal of jarring and jolting. Mounting the seat 130 and mechanism housing 120 upon the suspension mount 150 enables the jarring experienced by the passenger to be reduced.

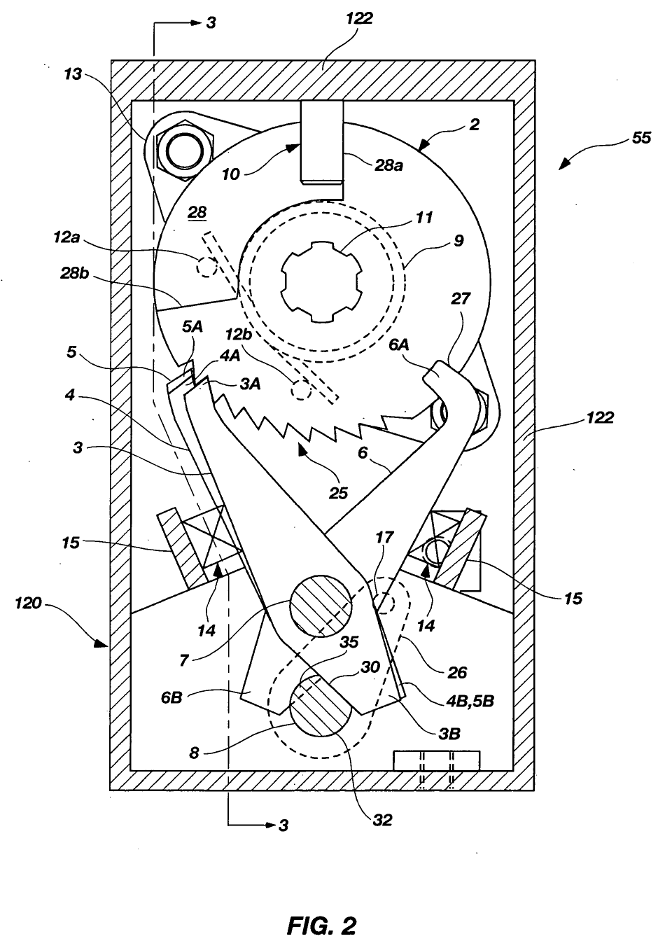

FIGS. 2 and 3 depict cross-sectional views of the positioning mechanism housing 120 and the positioning mechanism 55 therewithin. The positioning mechanism housing 120 may comprise a box having walls 122 of a material resistant to damage from rough use or impact, for example a metal such as steel, wood, or a plastic such as PVC. A box having metal walls 122 may be welded to seal the contents from foreign matter and contaminants such as water or dust. An optional seal 18 about the release shaft 8 which protrudes from the housing 120 may further protect the contents. Another seal may optionally be provided about the restraint bar shaft 11 which also protrudes from the housing. The seal may comprise, for example a mechanical shaft seal or a lip seal of Teflon or rubber.

A ratchet wheel 2 is coaxial with the restraint bar shaft 11, and rotates therewith. Referring to FIG. 2, the ratchet wheel 2 includes a plurality of directional teeth 25 along a portion of the circumference thereof. The directional teeth 25 are asymmetrical, for selective engagement. Three pawls 3, 4, 5, may be pivotally mounted on a pawl shaft 7. First ends 3A, 4A, 5A of the pawls 3, 4, 5 may comprise engagement tips configured to be received by the directional teeth 25. The first end 3A, 4A, 5A of one of three pawls 3, 4, 5 engages with the directional teeth 25 of the ratchet wheel 2, preventing the ratchet from turning in a counterclockwise direction. Pawl 3 is depicted in an engaged position with the first end 3A thereof received by the teeth 25 of the ratchet wheel 2. The asymmetrical shape of the directional teeth 25 enable clockwise rotation of the ratchet wheel 2, even when a pawl 3, 4, 5, is engaged. Thus, an operator may bring the restraint bar down through a range of positions without engaging a release mechanism 60 at each position. However, to raise the restraint bar, the release mechanism 60 must be activated, as described hereinbelow.

Three pawls 3, 4, 5 having varying length enable fine adjustment of the ratchet mechanism. A turn of the ratchet wheel 2 of less than the frequency of the teeth will allow a different pawl, having a different length, to engage with the teeth 25. A plurality of different engaged positions of the ratchet wheel 2 and restraint shaft 11 are thus provided, and therefore a plurality of different operator restrained positions of the restraint bar 100 are provided. The three pawls also provide a back-up in case one pawl fails during an accident or other severe strain on the restraint mechanism. However, a ratchet mechanism having a single pawl, two pawls, or more than three pawls is within the scope of the present invention.

The restraint bar 100 may be locked in an upward position, preventing downward rotation, with an uplock pawl 6. A first end 6A of the uplock pawl 6 engages in an uplock notch 27 in the ratchet wheel 2 when the ratchet wheel 2 is in a rotational position corresponding to the generally vertical, open position of the restraint bar 100. The uplock pawl 6 may be released with the release mechanism 60, which may comprise the release lever 170, depicted in FIG. 1A, operably coupled with a release shaft 8. A clockwise rotation of the release shaft 8, which may be effected by a clockwise force by the operator on the release lever 170, will disengage the uplock pawl 6.

The release shaft 8 is substantially cylindrical; however it includes a first longitudinal portion having an uplock engagement surface 35, and a second longitudinal portion having a pawl engagement surface 30. FIG. 2 shows the cross-section of the second longitudinal portion of the release shaft 8, which is substantially circular, with a truncated portion at a chord thereof. The pawl engagement surface 30 comprises an extruded surface of the chord. A dashed line shows the uplock engagement surface 35, an extruded surface of another chord. The non-uniform, eccentric cross-sections of the first and second longitudinal portions of the release shaft 8 enable the release shaft 8 to function as a cam. The radial distance from the axis of the release shaft 8 to the pawl engagement surface 30 or the uplock engagement surface 35 is shorter than a distance from the axis of the release shaft 8 to a circumferential surface 32 thereof. Turning the release shaft 8 as little as an eighth of a turn will engage the circumferential surface 32 against a second end 6B of the uplock pawl 6, pivoting the uplock pawl 6 about the pawl shaft 7. The pivot action may disengage the first end 6A of the uplock pawl 6 from the uplock notch 27 of the ratchet wheel 2, enabling the ratchet wheel 2 to rotate freely. Likewise, the rotation of the release shaft 8 will engage the circumferential surface 32 against a second end 3B, 4B, 5B of the pawls 3, 4, 5, pivoting them about the pawl shaft 7. This pivot action may disengage the first ends 3A, 4A, 5A of pawls 3, 4, 5 from the teeth 25 of the ratchet wheel 2.

A bell crank 26 may be attached to the release shaft 8, at the opposite end from the release lever 170 (FIG. 1 A) and the portion of the release shaft 8 protruding from the housing 120. A biasing element 17 may connect the bell crank 26 with a wall 122 of the housing 120. When the release lever 170 has been turned to release the uplock pawl 6 and the three pawls 3, 4, 5, the biasing element 17 may urge the release shaft 8 back to a neutral position. In the neutral position, uplock engagement surface 35 may be adjacent the uplock pawl 6, and the pawl engagement surface 30 may be adjacent the pawls 3, 4, 5, enabling the first ends 6A, 3A, 4A, 5A of the uplock pawl 6 and pawls 3, 4, 5 to contact the ratchet wheel 2.

A return fence 15 is secured in place with respect to a baseplate 40, the floor of the housing 120, and located adjacent the pawls 3, 4, 5 and adjacent the uplock pawl 6. A resilient biasing element 14, for example, a spring, may be positioned between the return fence 15 and the pawls 3, 4, 5, biasing the pawls 3, 4, 5 to pivot about the pawl shaft 7 with the first ends 3A, 4A, 5A of the pawls 3, 4, 5 toward the ratchet wheel 2. A resilient biasing element 14 may additionally be positioned between the return fence 15 and the uplock pawl 6, causing the uplock pawl 6 to rotate about the pawl shaft 7 and biasing the first end 6A of the uplock pawl 6 toward the ratchet wheel 2.

The ratchet wheel 2 may be substantially cylindrical, with a limiting notch 28 therein. The limiting notch 28 may comprise a longitudinal portion of the ratchet having a wedge-shaped section of a lesser diameter. A limiter 10 may protrude from the interior of the housing 120. The limiter 10 may comprise, by way of example, a bolt, a screw or a pin passing through the housing 120. The ratchet wheel 2 may rotate from a first position, in which the limiter 10 engages a first end 28a of the limiting notch 28 to a second position, in which the limiter 10 engages a second end 28b of the limiting notch 28. The restraint bar shaft 11 rotates with the ratchet wheel 2; therefore the restraint bar 100 may travel no farther than the range of motion of the ratchet wheel 2. The range of motion of the ratchet wheel 2 may be between about 80 and 120 degrees of rotation, preferably about 100 degrees. The first position of the ratchet wheel 2 is shown in FIG. 2, wherein the limiter 10 is engaged with the first end 28a of the limiting notch 28, the uplock pawl 6 is engaged in the uplock notch 27, and the restraint bar 100 is in the upward, open position as shown in FIG. 1. The second position of the ratchet wheel 2 corresponds to the lowest restraining position of the restraint bar 100.

Counterweight spring 9 and counterweight retainer posts 12a, 12b provide an opposing torque to the torque on the shaft 11 created by the force of gravity on the pivoting restraint bar 100. The counterweight spring 9, which may be wound about the restraint bar shaft 11, and the counterweight retainer posts 12a, 12b may bias the restraint bar 100 against gravity to be raised more easily and to be lowered more gently than an unbiased restraint bar. FIG. 2 depicts the counterweight spring 9 in a neutral position, with the ratchet wheel 2 in the first position, and the restraint bar 100 in the upward position. As the restraint bar is lowered to the horizontal, closed position, the restraint bar shaft 11 is rotated, and the counterweight spring 9 is wound more tightly, storing the potential energy released by the change in elevation of the weight of the restraint bar 100. The resistance provided by the counterweight spring 9 may prevent the restraint bar from dropping too rapidly on a users lap. The counterweight retainer posts 12a, 12b keep the counterweight spring 9 in place. One counterweight post 12a may be attached to the ratchet wheel 2 and turn with the ratchet, engaging and winding the counterweight spring 9. Another counterweight post 12b may be secured to the housing, and provide resistance as the counterweight spring 9 is wound.

The counterweight spring 9 may also prevent the restraint bar 100 from tightening on the lap of an operator under the jarring and jolting forces on the restraint bar during vehicle operation. Some play, also known as backlash, is built into the three pawls 3, 4, 5 and the teeth in the ratchet wheel 2.

The shaft 11 may rotate within bearings 13 which may be secured to the housing 120 with attachment pins 20, such as bolts or screws. The bearings 13 may reduce wear on the shaft 11.

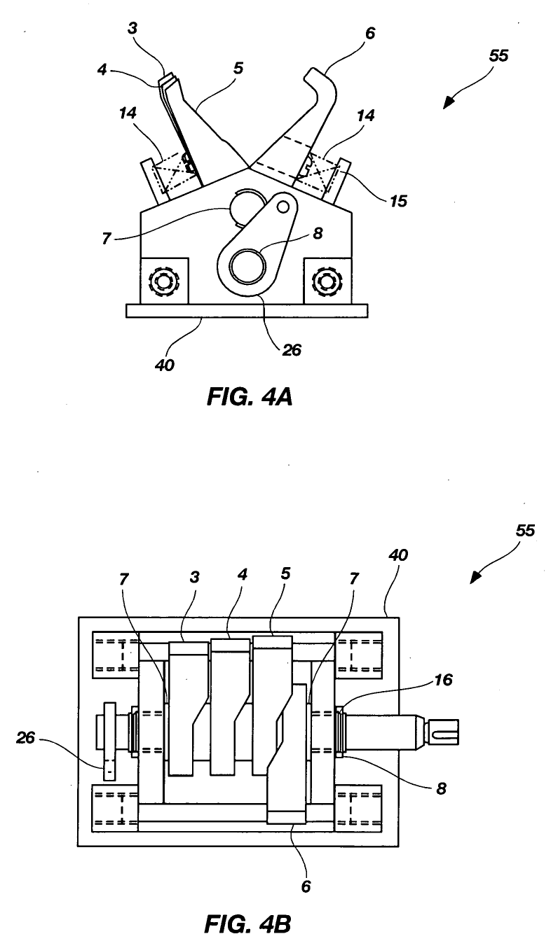

FIGS. 4A and 4B show a side view and a top view of portions of the positioning mechanism 55 without the ratchet wheel 2, for clarity. The pawls 3, 4, 5 are mounted in a longitudinally spaced manner along the pawl shaft 7. Uplock pawl 6 may be mounted at one end of the pawl shaft 7, and may extend from the pawl shaft 7 in a different radial direction than the pawls 3, 4, 5. Thus the pawls 3, 4, 5 and the uplock pawl 6 may contact the ratchet wheel 2 on opposing sides. The release shaft 8, pawl shaft 7, and return fence 15 may all be mounted upon the baseplate 40. The baseplate 40 may be removably attached to the walls 122 of the positioning mechanism housing 120. Thus, the positioning mechanism 55 is modular, and the components such as the pawls 3, 4, 5, release shaft 8, and pawl shaft 7 may all be easily accessed for removal and/or service.

The positioning mechanism 55 may be easily reconfigured for the restraint bar to be positioned on the left or right side of the vehicle occupant. The baseplate 40 may be removed from positioning mechanism housing 120, and the pawls 3, 4, 5 and the uplock pawl 6 may be remounted in an opposing configuration on the pawl shaft 7. Likewise, the ratchet wheel 2 may be remounted within the positioning mechanism housing 120 in opposing configuration, with directional teeth 25 engaging with the pawls 3, 4, 5 and preventing clockwise rotation of the ratchet wheel 2, rather than prevention of counterclockwise rotation as shown in FIG. 2.

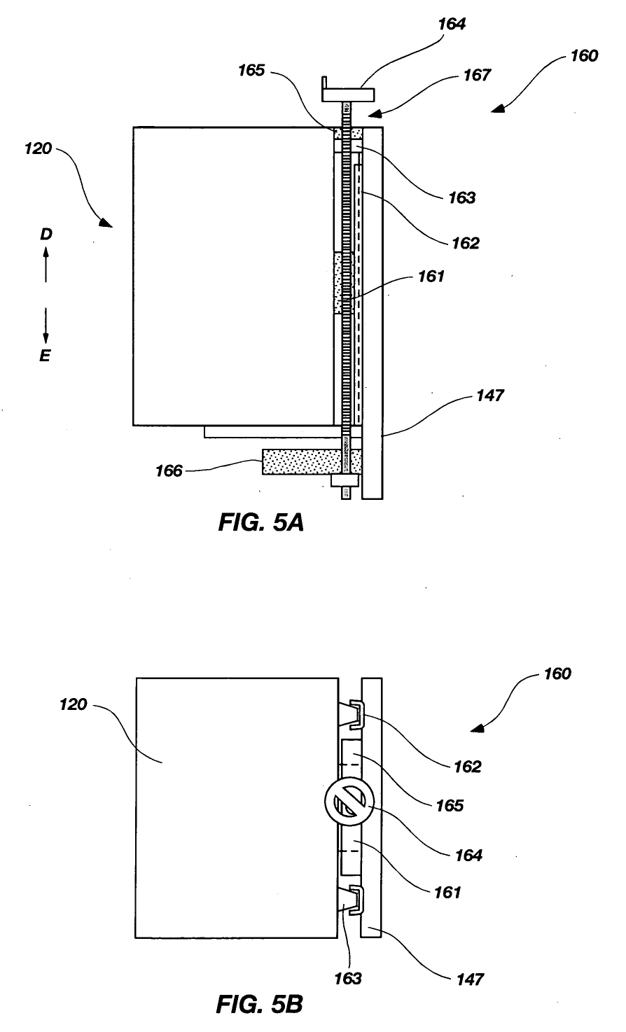

FIGS. 5A and 5B depict a fine adjustment mechanism 160. The fine adjustment mechanism 160 enables the positioning mechanism housing 120 to be adjusted horizontally, forward or backward with respect to the seat 130, depending on the manner the positioning mechanism housing 120 is mounted on the fine adjustment mechanism 160. The restraint bar 100 may be maneuvered closer to the hips of the vehicle occupant for greater restraint or use by a petite occupant. The restraint bar 100 may be positioned closer to the knees of the vehicle occupant, for more freedom of movement or use by a larger occupant. The fine adjustment mechanism 160 may additionally enable the housing 120 to be adjusted vertically in the directions of arrows D and E with respect to the seat 130, if the positioning mechanism housing 120 is mounted with rails 162 of the fine adjustment mechanism 160 in a vertical configuration. For an operator having larger legs, it may be desirable to have the restraint bar 100 a greater height from the seat, and still in a substantially horizontal position.

The fine adjustment mechanism 160 may include a rotary to linear conversion mechanism, for example a ball screw 167 with an adjusting handle 164 coupled thereto. The bracket 147, which may be mounted beside the seat 130 as shown in FIG. 1B, may have a first support bearing 165 and a second support bearing 166 protruding therefrom. The ball screw 167 may be rotatably mounted between the first and second support bearings 165, 166. The ball screw 167 may rotate within a drive housing 161, wherein the rotary motion of the ball screw 167 may be converted to linear motion of the drive housing 161. The drive housing 161 may be attached to the positioning mechanism housing 120, and thus the positioning mechanism housing 120 and the restraint bar 100 may be linearly repositioned. Tracks 163 protruding from the positioning mechanism housing 120 may be received within rails 162 on the bracket 147. The tracks 163 and rails 162 may provide additional support for the positioning mechanism housing 120.

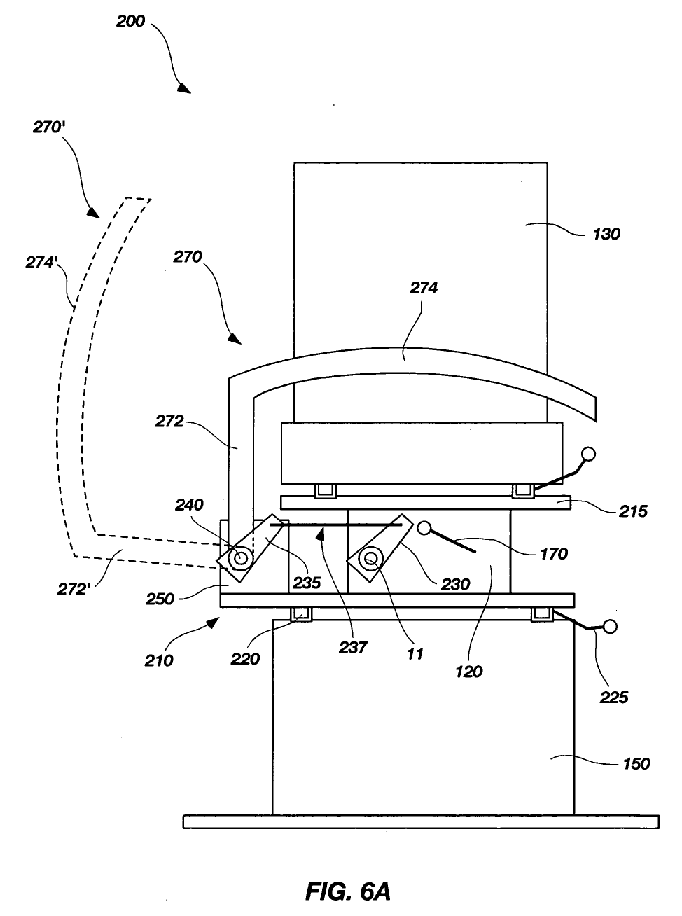

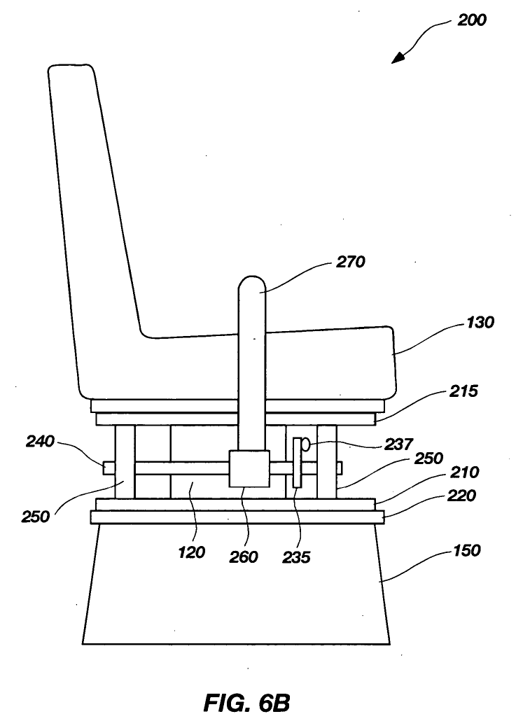

FIG. 6A depicts a front view of another embodiment of a restraint system 200 of the present invention, with the positioning mechanism housing 120 mounted under the seat 130. A first adaptor plate 210 is mounted on slide rails 220 on a suspension box 150. It will be understood by one skilled in the art that the first adaptor plate 210 may be mounted directly to a vehicle, without a suspension box 150. The first adaptor plate 210 may be adjustable in the fore and aft direction, with respect to a seated vehicle occupant, on rails 220. Adjustment lever 225 may release a biased protrusion, enabling the first adaptor plate 210 to be moved, then secured in the desired position. The positioning mechanism housing 120 and positioning mechanism 55 (not shown) therein may be mounted on the first adaptor plate 210 below the seat 130. The restraint bar shaft 11 protruding from the positioning mechanism housing is operably coupled with a bell crank 230, connected with a linkage 237 to a second bell crank 235, mounted on a second shaft 240 which is rotatable therewith. The second shaft 240 rotates with the pivoting of the restraint bar 270, mounted thereon. The raising or lowering of the restraint bar 270 and the subsequent rotation of the restraint bar shaft 11 will thus be aided or resisted by the positioning mechanism 55, although the restraint bar 270 is not directly mounted on the restraint bar shaft 11, and the positioning mechanism housing 120 is located beneath, rather than beside, the seat 130.

FIG. 6B depicts a side view of the restraint system 200 of FIG. 6A. The second shaft 240 is mounted between support brackets 250, and the second bell crank 235 and a shaft hub 260 are mounted on the second shaft 240. The L-shaped restraint bar 270 is secured to the shaft hub 260. The L-shape of the restraint bar 270 provides, in the restraining position shown in FIGS. 6A and 6B, a first portion 272 extending from the height of the second shaft 240 and shaft hub 260 below the seat 130 to a position above the seat 130 in a substantially vertical orientation. A second portion 274 may extend substantially horizontally manner from the end of the first portion 272 across the seat 130 and may restrain an occupant (not shown) seated thereupon. The second portion 274 of the restraint bar 270 may be bowed, extending toward the seat 130 at each end. FIG. 6A depicts with dashed lines, the lap bar 270′ in an upright, non-restraining position. The restraint bar first portion 272′ extends from the shaft hub 260 substantially horizontally away from the seat 130, and the second portion 274′ of the restraint bar is positioned substantially vertically, enabling occupant ingress and egress from the seat 130.

A second adaptor plate 215 may be mounted upon the positioning mechanism housing 120 and carry rails enabling fore and aft seat adjustment with respect to the restraint bar 270.

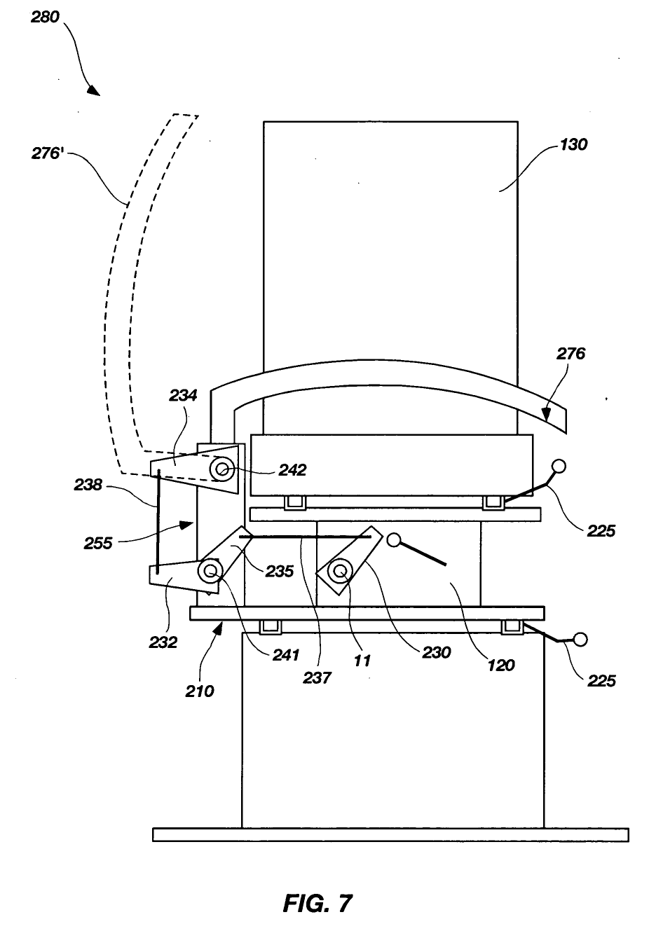

FIG. 7 depicts a front view of another embodiment of a restraint system 280 of the present invention, with a series of bell cranks 230, 235, 232, 234 and linkages 237, 238 operably connecting the restraint bar 276 with the restraint bar shaft 11. The restraint bar shaft 11 protruding from the positioning mechanism housing is operably coupled with a bell crank 230, connected with a linkage 237 to a second bell crank 235, mounted on a second shaft 241 which is rotatable therewith. A third bell crank 232 rotates with the second shaft 241, and is connected with a second linkage 238 to a fourth bell crank 234. A third shaft 242 is coupled with the fourth bell crank 234, and rotates with the pivoting of the restraint bar 276, mounted thereon. The raising or lowering of the restraint bar 276 between the generally horizontal, operator restrained position shown in solid lines, and the generally vertical, open position 276′ shown with dashed lines will operate the series of bell cranks 230, 235, 232, 234 and linkages 237, 238, connecting the restraint bar 276 with the restraint bar shaft 11.

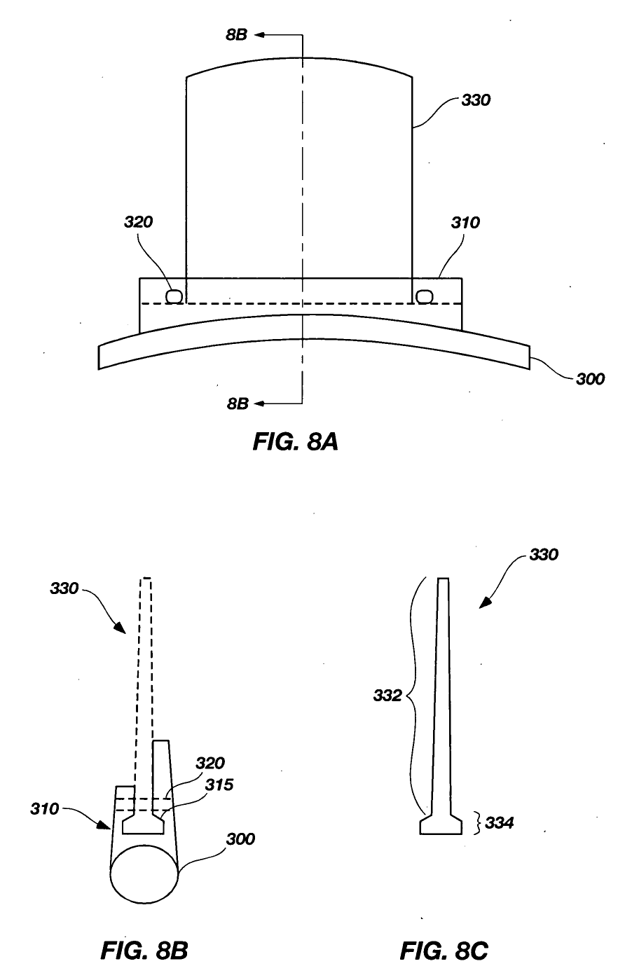

Another embodiment of a restraint bar 300 of the present invention is depicted in FIG. 8A and includes an armor plate 330 attached thereto. The armor plate 330 may comprise, by way of example, metal, ceramic, or Kevlar or any other material suitable to resist penetration by bullets and other ballistic projectiles. Including the armor plate 330 as a shield may be useful to provide localized protection, in the region of a vehicle occupant, without the increased weight of armor covering an entire vehicle. Including the armor plate 330 on the restraint bar enables the armor plate 330 to be adjustable, that is, the armor plate 330 may be positioned differently for an individual of a different size. The armor plate 330 may be included in a vehicle of any size sufficient to enable the restraint bar to pivot between the upright position and the restraining position.

The restraint bar 300 may include a mount 310 which may be formed integrally with the restraint bar 300, or may be secured thereon, for example with an adhesive or by welding. The mount 310 may include an elongated cavity 315 with a dovetail-shaped cross-section to secure the armor plate 330 therein and provide lateral support. The armor plate 330 may comprise a substantially planar body portion 332 and a dovetail attachment portion 334 along one edge thereof. The dovetail attachment portion 334 may be secured within the elongated cavity 315 with attachment elements 320. Attachment elements 320 may comprise, by way of example, screws, bolts or pins. The body portion 332 of the armor plate may have a lesser lateral dimension than the dovetail attachment portion 334, and the body portion 332 may extend from the mount 310 through the elongated cavity 315. Thus, the body portion 332 of the armor plate 330 extends from the restraint bar 300. When the vehicle occupant is in a seated position, secured by the restraint bar 300, the armor plate 330 may protect the chest region of the vehicle occupant.

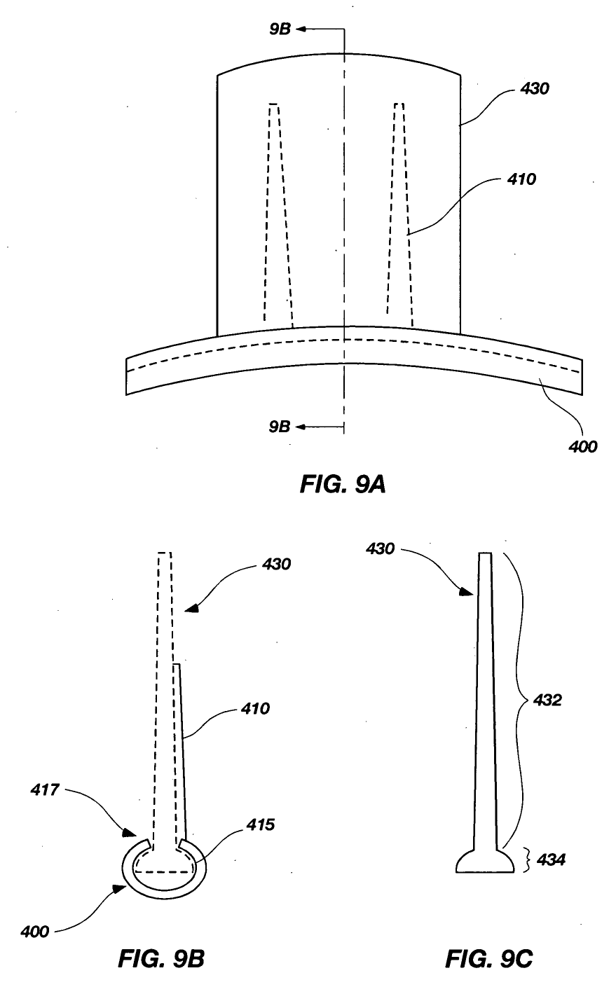

FIGS. 9A through 9C depict another embodiment of a restraint bar 400 with an armor plate 430. The restraint bar 400 may comprise a cylindrical body with a hollow region or cavity 415 longitudinally disposed therein. The cylindrical body of the restraint bar 400 need not have a circular cross-section, but may have an elliptical cross-section, as shown. The restraint bar 400 may further include a longitudinally extending opening 417, providing access to the cavity 415. The armor plate 430 may comprise a substantially planar body portion 432 and a fan-shaped attachment portion 434 along one edge thereof as shown in FIG. 9C. The fan-shaped attachment portion 434 may be removably secured within the cavity 415 and the planar body portion 432 may extend from the longitudinally extending opening 417 of the restraint bar 400.

At least one support 410 may protrude upward from the restraint bar 400 adjacent the armor plate 430 for lateral support thereof. The support 410 may be integrally formed with the restraint bar 400 or may be attached, for example, by welding.

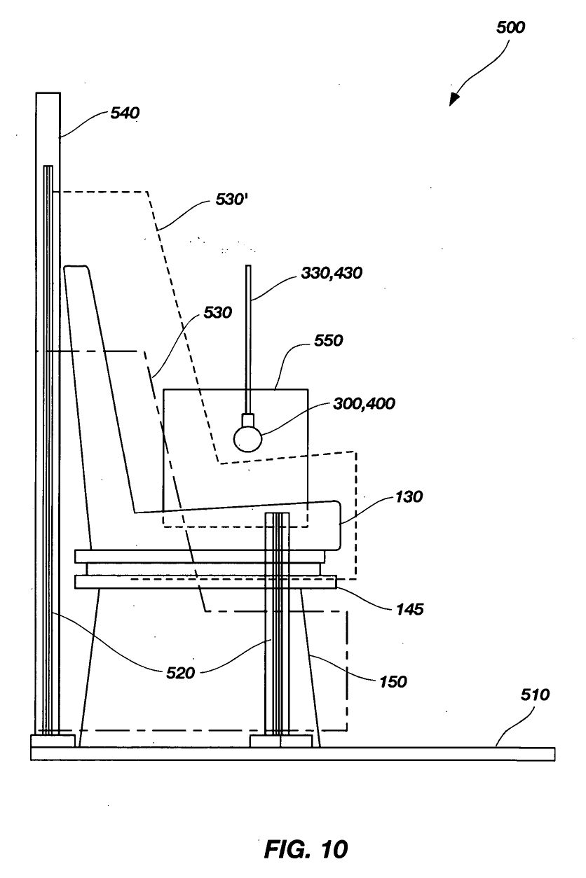

FIG. 10 depicts yet another embodiment of a restraint system of the present invention. In addition to an armor plate 330, 430 secured to the restraint bar 300, 400, the restraint system includes a floor plate 510 and side plates 530 of a projectile-resistant material. The side plates may be slideable between an upper 530′ and a lower position 530 on rails 520. The side plates may provide more protection for the torso, head and neck regions in the upper position 530′ and enable more freedom of movement in the lower position 530. In addition, a roll plate 540 of ballistic material may be provided behind the seat 130, for protection from projectiles as well as protection in the event of a roll-over accident. Another optional side armor plate 550 may be attached to the distal end of the restraint bar 300, 400. The side armor plate 550 may pivot with the restraint bar 300, 400 and provide torso protection for a seated occupant with the restraint bar 300, 400 in the generally horizontal, operator restrained position.

Although specific embodiments have been shown by way of example in the drawings and have been described in detail herein, the invention may be susceptible to various modifications, combinations, and alternative forms. For example, a restraint bar mounted on the left or right side of a seat is within the scope of the present invention. In addition, the fine adjustment mechanism 160 may be provided on the adjustment plate 210 of the restraint system 200 of FIGS. 6A and 6B. Therefore, it should be understood that the invention is not intended to be limited to the particular forms disclosed. Rather, the invention includes all modifications, equivalents, combinations, and alternatives falling within the spirit and scope of the invention as defined by the following appended claims.

1. A restraint system for an occupant of a vehicle, comprising:
a positioning mechanism;
a shaft protruding from the positioning mechanism, the shaft rotatable in a first direction and releasably fixed from rotation in a second, opposing direction;
a release mechanism coupled with the positioning mechanism which may be manipulated by the occupant to enable the shaft to rotate in the second, opposing direction; and
a restraint bar coupled with the shaft to pivot with the shaft between at least two restraining positions and an open position.

2. The restraint system of claim 1, further comprising a housing enclosing the positioning mechanism, the shaft protruding from the housing.

3. The restraint system of claim 1, wherein the positioning mechanism comprises:
a ratchet wheel rotatable with the shaft and having a plurality of teeth circumferentially disposed thereabout; and
at least one positioning pawl engageable with the plurality of teeth of the ratchet wheel.

4. The restraint system of claim 3, further comprising an uplock pawl engageable with the ratchet wheel while the restraint bar is in the open position.

5. The restraint system of claim 3, further comprising a counterweight operably coupled with the shaft.

6. The restraint system of claim 3, wherein the release mechanism comprises a mechanism configured to disengage the at least one positioning pawl from the plurality of teeth of the ratchet wheel.

7. The restraint system of claim 1, wherein the restraint bar comprises a first portion and a second portion orthogonally disposed to the first portion.

8. The restraint system of claim 7, wherein the restraint bar is coupled with the shaft by a linkage comprising:
a first bell crank attached to the shaft;
a linkage bar connecting the first bell crank with a second bell crank;
a second shaft attached to the second bell crank; and
a shaft hub securing the second shaft with an end of the restraint bar.

9. The restraint system of claim 7, wherein the restraint bar is coupled with the shaft by a linkage comprising:
a first bell crank attached to the shaft;
a first linkage bar connecting the first bell crank with a second bell crank;
a second linkage bar connecting the second bell crank with a third bell crank;
a second shaft attached to the third bell crank; and
a shaft hub securing the second shaft with an end of the restraint bar.

10. The restraint system of claim 1, further comprising an armor plate attached to the restraint bar.

11. The restraint system of claim 10, wherein the restraint bar comprises an elongated, annular bar having a cavity therein, and the armor plate comprises a substantially planar portion extending in a radial direction from the restraint bar and a fan-shaped attachment portion receivable by the cavity of the restraint bar.

12. A method of restraining an occupant of a vehicle, comprising:
providing a seat for the vehicle occupant comprising a seat back and a seat bottom;
pivoting a restraint bar in a plane substantially parallel to a plane of the seat back to a first position near a lap of the vehicle occupant;
preventing upward pivoting action of the restraint bar; and
pivoting the restraint bar to a second position closer to the lap of the vehicle occupant.

13. The method of claim 12, wherein preventing upward pivoting action of the restraint bar comprises engaging directional teeth of a ratchet wheel with a pawl, the ratchet wheel coupled with restraint bar to rotate therewith.

14. The method of claim 13, further comprising:
manipulating a release mechanism operably coupled with the restraint bar; and
pivoting the restraint bar upward to a third, substantially vertical position.

15. The method of claim 14, wherein manipulating the release mechanism comprises:
rotating a release shaft have eccentric longitudinal portions contacting the pawl; and
pivoting the pawl and releasing the directional teeth of the ratchet from engagement with the pawl.

16. The method of claim 13, further comprising biasing the pawl toward engagement with the directional teeth of the ratchet wheel.

17. The method of claim 16, further comprising biasing a plurality of pawls toward engagement with the directional teeth of the ratchet wheel.

18. A restraint system for an occupant of a vehicle, comprising:
a positioning mechanism comprising:
a ratchet wheel having a plurality of directional teeth circumferentially disposed thereon;
at least one pawl having a first end biased toward engagement with the ratchet wheel;
a release shaft having an eccentric longitudinal portion, the eccentric longitudinal portion contacting a second end of the pawl shaft; and
a restraint bar shaft attached to the ratchet wheel;
a restraint bar coupled with the restraint bar shaft pivotable between at least two restraining positions and an open position.

19. The restraint system of claim 18, further comprising:
an uplock pawl having a first end biased toward engagement with the ratchet wheel; and
an uplock notch in the ratchet wheel, configured to receive the first end of the uplock pawl and prevent rotation of the ratchet wheel.

20. The restraint system of claim 18, further comprising an armor plate extending from the restraint bar.
